(19) United States
(12) Patent Application Publication
(10) Pub. No.: US 2019/0384282 A1
(43) Pub. Date: Dec. 19, 2019

(54) AUTONOMOUS VEHICLE FOR CARRYING GROUP OF MULTIPLE USERS, METHOD OF CONTROLLING THE SAME, AND CONTROL SERVER FOR CONTROLLING THE SAME

(71) Applicant: LG Electronics Inc., Seoul (KR)

(72) Inventors: Hyunsoo KIM, Seoul (KR); Tae Kwon KANG, Seoul (KR); Geonghwan YU, Seoul (KR); Sun Yup KIM, Seoul (KR); Hyunsang PARK, Seoul (KR)

(21) Appl. No.: 16/557,916

(22) Filed: Aug. 30, 2019

(30) Foreign Application Priority Data
Aug. 5, 2019 (KR) 10-2019-0095203

(51) Int. Cl. G05D 1/00; G05D 1/02; G08G 1/00; H04W 4/48

(52) U.S. Cl. CPC G05D 1/0027; G05D 1/0295; G05D 1/0246; H04W 4/48; G08G 1/22; G08G 1/20; G05D 1/0293

(57) ABSTRACT

An autonomous vehicle for carrying a group of multiple users, a method of controlling the same, and a control server for controlling the same are disclosed. The autonomous vehicle includes: a plurality of displays disposed therein; a plurality of speakers disposed therein; a communication unit receiving, in real time, an internal image of at least one other vehicle autonomously driving in a platoon with the vehicle and an internal audio signal corresponding to the internal image; and a controller controlling at least some of the plurality of displays to display the internal image in real time and controlling the plurality of speakers to output the internal audio signal in real time. The autonomous vehicle according to the present invention may be a vehicle that can drive by itself to a destination without human intervention.

### CROSS-REFERENCE TO RELATED APPLICATION

This application claims the benefit of Korean Patent Application 10-2019-0095203, filed on Aug. 5, 2019 in the Korean Intellectual Property Office, the entire disclosure of which is incorporated herein by reference.

### FIELD

The present invention relates to an autonomous vehicle for carrying a group of multiple users, a method of controlling the same, and a control server for controlling the same.

### BACKGROUND

A vehicle is a device that allows a user to travel to a predetermined destination. A representative example of the vehicle is an automobile.

Recently, not only automobile companies but also electronics companies are rushing into development of autonomous vehicles. An autonomous vehicle performs autonomous driving through communication with an external device, for example, a control server, or through perception and awareness of surroundings using various sensors attached thereto.

When a user group including multiple users who know one another (for example, a traveler group whose members are mutual friends) intends to use such an autonomous vehicle, the users generally want to take a ride in one autonomous vehicle. However, if the number of users exceeds the seating capacity of one autonomous vehicle, the users need to split into different autonomous vehicles. In general, such a user group wants to have the same experience in one space, especially whilst traveling in an autonomous vehicle.

Therefore, there is a need for a technology that allows multiple users using plural autonomous vehicles to have the same experience.

### SUMMARY

It is an aspect of the present invention to provide an autonomous vehicle which provides a service by which multiple users who know each other can enjoy the same experience even when split into plural autonomous vehicles, a method of controlling the same, and a control server for controlling the same.

The above and other aspects and advantages of the present invention will become apparent from the detailed description of the following embodiments in conjunction with the accompanying drawings. In addition, it will be readily understood that the aspects and advantages of the present invention can be realized by features set forth in the appended claims or combinations thereof.

In accordance with one aspect of the present invention, an autonomous vehicle includes: a plurality of displays disposed therein; a plurality of speakers disposed therein; a communication unit receiving, in real time, an internal image of at least one other vehicle autonomously driving in a platoon with the vehicle and an internal audio signal corresponding to the internal image; and a controller controlling at least some of the plurality of displays to display the internal image in real time and controlling the plurality of speakers to output the internal audio signal in real time.

In accordance with another aspect of the present invention, a control server includes: a communication unit communicating with a plurality of vehicles performing autonomous driving; and a controller controlling autonomous driving of the plurality of vehicles, wherein, when the plurality of vehicles travels in a platoon, the communication unit receives, in real time, an internal image of each of the plurality of vehicles and an internal audio signal corresponding to the internal image, the controller generates information about platooning-related services for the plurality of vehicles based on the received internal image and internal audio signal, and the communication unit transmits, in real time, the information about platooning-related services to the plurality of vehicles, and wherein the information about platooning-related services for a first vehicle among the plurality of vehicles includes an internal image and internal audio signal of each of the other vehicles.

In accordance with a further aspect of the present invention, a method of controlling an autonomous vehicle includes: receiving, by a communication unit of the vehicle, in real time, an internal image of at least one other vehicle autonomously driving in a platoon with the vehicle and an internal audio signal corresponding to the internal image; displaying, by at least some of a plurality of displays of the vehicle, the internal image in real time; and outputting, by a plurality of speakers of the vehicle, the internal audio signal in real time.

According to embodiments of the invention, it is possible to provide a service by which multiple users can enjoy the same experience even when split into plural autonomous vehicles.

It should be understood that the present invention is not limited to the effects described above and various other effects of the present invention can be easily conceived from the features of the present invention by those skilled in the art.

### DRAWINGS

FIG. 1 is a diagram of an example of basic operation of communication between an autonomous vehicle and a 5G network in a 5G communication system.

FIG. 2 is a diagram of an example of application operation of an autonomous vehicle and a 5G network in a 5G communication system.

FIG. 3 to FIG. 6 are diagrams of respective examples of operation of an autonomous vehicle using 5G communication.

FIG. 7 is a schematic diagram of a system according to one embodiment of the present invention.

FIG. 8 is a sectional view of an autonomous vehicle according to one embodiment of the present invention.

FIG. 9 is a plan view of the autonomous vehicle.

FIG. 10 is a block diagram illustrating control relations between components of the autonomous vehicle.

FIG. 11 is a schematic diagram of a control server according to one embodiment of the present invention.

FIG. 12 is a flowchart illustrating operation of a control server to select a plurality of autonomous vehicles to provide driving services to a user group according to one embodiment of the present invention.

FIG. 13 is a flowchart illustrating a method of providing platooning-related services to a first vehicle among vehicles traveling in a platoon according to one embodiment of the present invention.

FIG. 14 is a diagram illustrating an embodiment of a process of providing platooning control-related services to three vehicles traveling in a platoon.

FIG. 15 is a diagram illustrating an embodiment of a process of providing platooning control-related services to two vehicles traveling in a platoon.

### DETAILED DESCRIPTION

Hereinafter, embodiments of the present invention will be described with reference to the accompanying drawings such that the present invention can be easily implemented by those skilled in the art. It should be understood that the present invention may be embodied in different ways and is not limited to the following embodiments.

In the drawings, portions irrelevant to the description will be omitted for clarity. Like components will be denoted by like reference numerals throughout the specification. Further, some embodiments of the present invention will be described in detail with reference to the exemplary drawings. Here, like reference numerals are used to denote like elements even when the elements are shown in different drawings. Description of known functions and constructions which may unnecessarily obscure the subject matter of the present invention will be omitted.

It will be understood that, although the terms “first”, “second”, “A”, “B”, “(a)”, “(b)”, and the like may be used herein to describe various elements, components, regions, layers and/or sections, the nature, order, sequence, or number of these elements, components, regions, layers and/or sections should not be limited by these terms. These terms are only used to distinguish one element, component, region, layer or section from another element, component, region, layer or section. In addition, when a certain element or component is referred to as being “connected to”, “coupled to” or “joined to” another element or component, it means that these elements or components may be directly connected to, coupled to or joined to each other or through another element or component, or another element or component may be “interposed” therebetween.

It will be understood that, although components may be individually described in each embodiment of the present invention for convenience of description, these components may be implemented as one device or module, or one component may be commonly implemented in plural devices or modules.

An autonomous vehicle according to the present invention may be a vehicle that can drive by itself to a destination without human intervention. Such an autonomous vehicle may be associated with artificial intelligence (AI) modules, drones, unmanned aerial vehicles, robots, augmented reality (AR) modules, virtual reality (VR) modules, 5G (5th Generation) mobile communication devices, and the like.

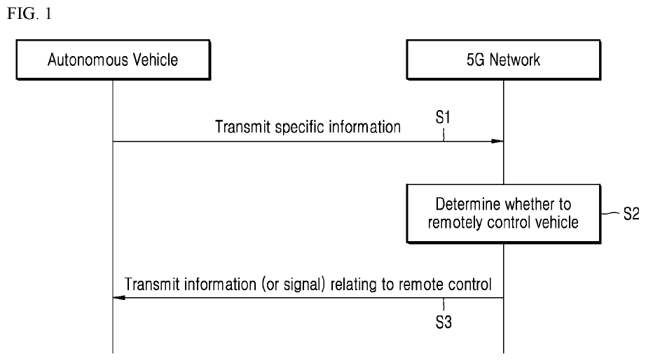

FIG. 1 is a diagram of an example of basic operation of communication between an autonomous vehicle and a 5G network in a 5G communication system.

As used herein, “autonomous driving” refers to a self-driving capability, and “autonomous vehicle” refers to a vehicle that operates without user intervention or with minimal user intervention.

For example, autonomous driving may include various functions, including lane keeping, automatic speed adjustment such as adaptive cruise control, automatic driving along a predetermined route, and automatic determination of a route to a preset destination.

As used herein, “vehicle” may include vehicles using only an internal combustion engine, hybrid vehicles using both an internal combustion engine and an electric motor, and electric vehicles using only an electric motor, including trains and motorcycles as well as automobiles.

Herein, an autonomous vehicle may be considered as an autonomous driving robot.

Now, an example of basic operation of communication between an autonomous vehicle and a 5G network will be described with reference to FIG. 1. For convenience of description, the autonomous vehicle will also be referred to as “vehicle”.

The vehicle may transmit specific information to the 5G network (51).

The specific information may include information relating to autonomous driving.

The information relating to autonomous driving may be information directly relating to control over driving of the vehicle. For example, the information relating to autonomous driving may include at least one selected from the group consisting of object data indicating an object around the vehicle, map data, vehicle status data, vehicle position data, and driving plan data.

The information relating to autonomous driving may further include service information necessary for autonomous driving. For example, the specific information may include information relating to a destination input through a user terminal device and stability level of the vehicle. The 5G network may determine whether to remotely control the vehicle (S2).

Here, the 5G network may include a server or module that performs remote control relating to autonomous driving.

In addition, the 5G network may transmit information (or signals) relating to remote control to the vehicle (S3). The information relating to remote control may be a signal directly applied to the vehicle and may further include service information necessary for autonomous driving.

In one embodiment, the vehicle may receive service information, such as stretch-specific insurances and dangerous stretches on a route of travel, through a server connected to the 5G network, thereby providing services relating to autonomous driving.

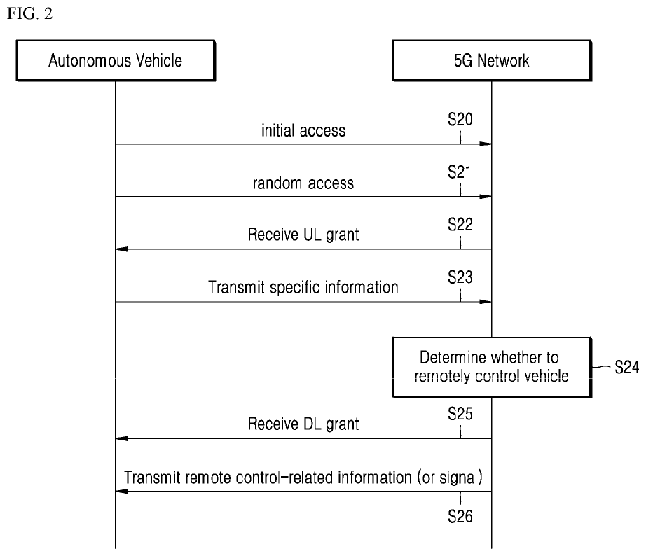

Now, a necessary process for 5G communication between a vehicle and a 5G network (for example, a procedure for initial access between an autonomous vehicle and a 5G network) for the purpose of providing stretch-specific insurance services applicable to the vehicle during autonomous driving will be described with reference to FIG. 2 to FIG. 6.

FIG. 2 is a diagram of an example of application operation of a vehicle and a 5G network in a 5G communication system.

The vehicle may perform a procedure for initial access to the 5G network (S20).

The initial access procedure may include cell search for downlink (DL) operation acquisition, acquisition of system information, and the like.

The vehicle may perform a procedure for random access to the 5G network (S21).

The random access procedure may include preamble transmission for uplink (UL) synchronization acquisition or UL data transmission, reception of a response to random access, and the like.

The 5G network may transmit a UL grant for scheduling transmission of specific information to the vehicle (S22).

UL grant reception may include receiving time/frequency resource scheduling for UL data transmission from the 5G network.

The vehicle may transmit specific information to the 5G network based on the UL grant (S23).

The 5G network may determine whether to remotely control the vehicle (S24).

The vehicle may receive a DL grant through a physical downlink control channel in order to receive a response to the specific information from the 5G network (S25).

The 5G network may transmit information (or signals) relating to remote control to the vehicle based on the DL grant (S26).

Although combination of initial access between an autonomous vehicle and a 5G network with random access and downlink grant reception is illustrated as performed through steps S20 to S26 in FIG. 2, it will be understood that the present invention is not limited thereto.

For example, initial access and/or random access may be performed through steps S20, S22, S23, S24, and S26. Alternatively, initial access and/or random access may be performed through steps S21, S22, S23, S24, and S26. In addition, combination of AI operation with downlink grant reception may be performed through step S23, step S24, step S25, and step S26.

Further, although control over operation of an autonomous vehicle is illustrated as performed through steps S20 to S26, it will be understood that the present invention is not limited thereto.

For example, operation of the autonomous vehicle may be achieved through selective combination of steps S20, S21, S22, and S25 with steps S23 and S26. Alternatively, operation of the autonomous vehicle may be composed of steps S21, S22, S23, and S26. Alternatively, operation of the autonomous vehicle may be composed of steps S20, S21, S23, and S26. Alternatively, operation of the autonomous vehicle may be composed of steps S22, S23, S24, and S26.

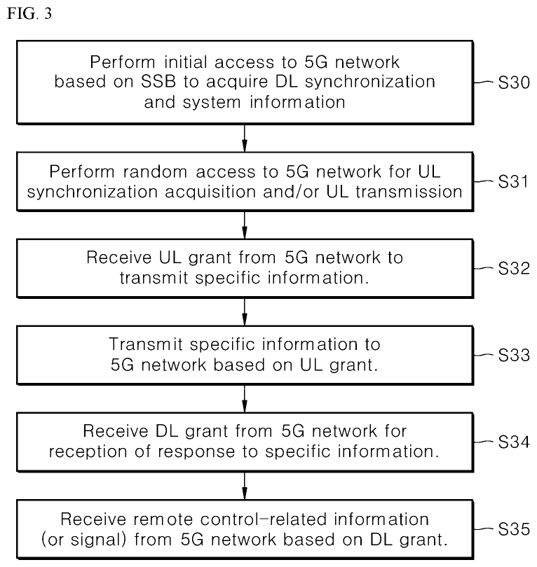

FIG. 3 to FIG. 6 are diagrams illustrating respective examples of operation of an autonomous vehicle using 5G communication.

Referring to FIG. 3, a vehicle including an autonomous driving module may perform a procedure of initial access to a 5G network based on a synchronization signal block (SSB) to acquire DL synchronization and system information (S30).

The vehicle may perform a procedure for random access to the 5G network for UL synchronization acquisition and/or UL transmission (S31).

The vehicle may receive a UL grant from the 5G network to transmit specific information (S32).

The vehicle may transmit the specific information to the 5G network based on the UL grant (S33).

The vehicle may receive a DL grant from the 5G network for reception of a response to the specific information (S34).

The vehicle may receive information (or signals) relating to remote control from the 5G network based on the DL grant (S35).

In step S30, beam management (BM) may be added. In addition, in step S31, beam failure recovery relating to transmission of a physical random access channel (PRACH) may be added. Further, in step S32, a QCL relation may be added, regarding beam reception direction of a PDCCH including the UL grant. Moreover, in step S33, a QCL relation may be added, regarding beam transmission direction of a physical uplink control channel (PUCCH)/a physical uplink shared channel (PUSCH) including the specific information. Furthermore, in step S34, a QCL relation may be added, regarding a beam reception direction of a PDCCH including the DL grant.

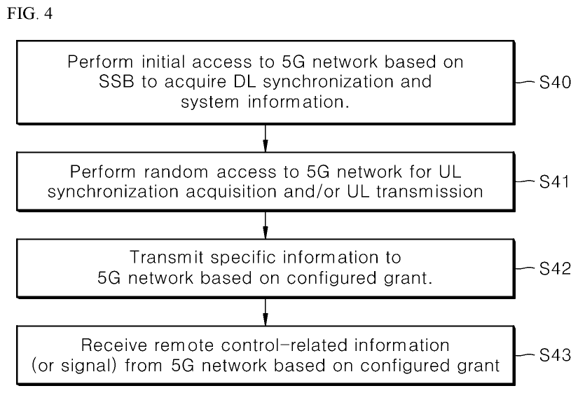

Referring to FIG. 4, the vehicle may perform a procedure for initial access to the 5G network based on an SSB to acquire DL synchronization and system information (S40).

The vehicle may perform a procedure for random access to the 5G network for UL synchronization acquisition and/or UL transmission (S41).

The vehicle may transmit specific information to the 5G network based on a configured grant (S42). In other words, the vehicle may transmit the specific information to the 5G network based on the configured grant, rather than receiving a UL grant from the 5G network.

The vehicle may receive information (or signals) relating to remote control from the 5G network based on the configured grant (S43).

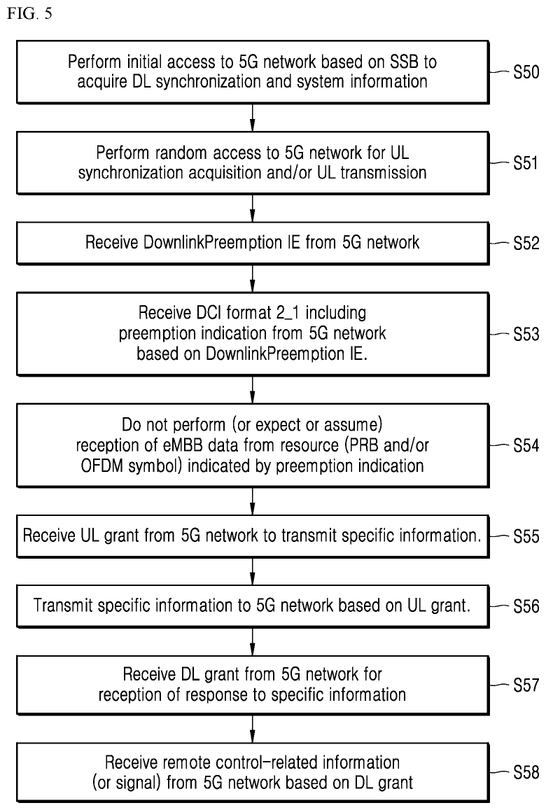

Referring to FIG. 5, the vehicle may perform a procedure for initial access to the 5G network based on an SSB to acquire DL synchronization and system information (S50).

The vehicle may perform a procedure for random access to the 5G network for UL synchronization acquisition and/or UL transmission (S51).

The vehicle may receive a DownlinkPreemption IE from the 5G network (S52).

The vehicle may receive DCI format 2_1 including a preemption indication from the 5G network based on the DownlinkPreemption IE (S53).

The vehicle may not perform (or expect or assume) reception of eMBB data from a resource (PRB and/or OFDM symbol) indicated by the preemption indication (S54).

The vehicle may receive a UL grant from the 5G network to transmit specific information (S55).

The vehicle may transmit the specific information to the 5G network based on the UL grant (S56).

The vehicle may receive a DL grant from the 5G network for reception of a response to the specific information (S57).

The vehicle may receive information (or signals) relating to remote control from the 5G network based on the DL grant (S58).

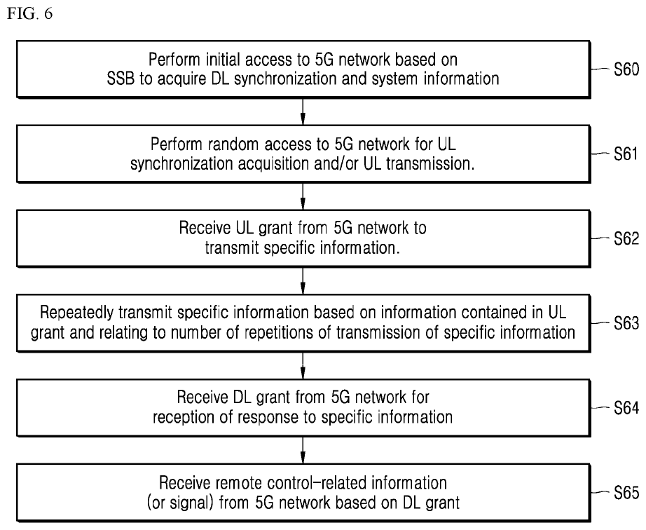

Referring to FIG. 6, the vehicle may perform a procedure for initial access to the 5G network based on an SSB to acquire DL synchronization and system information (S60).

The vehicle may perform a procedure for random access to the 5G network for UL synchronization acquisition and/or UL transmission (S61).

The vehicle may receive a UL grant from the 5G network to transmit specific information (S62). Here, the UL grant may include information about the number of repetitions of transmission of the specific information.

The vehicle may repeatedly transmit the specific information based on the information about the number of repetitions of transmission of the specific information (S63).

Repeated transmission of the specific information may be performed through frequency hopping, wherein a first type of specific information may be transmitted from a first frequency resource and a second type of specific information may be transmitted from a second frequency resource.

The specific information may be transmitted through a narrowband of 6RB (resource block) or 1RB.

The vehicle may receive a DL grant from the 5G network for reception of a response to the specific information (S64).

The vehicle may receive information (or signals) relating to remote control from the 5G network based on the DL grant (S65).

The 5G communication technology as described above may be applied to embodiments described further below and may help to embody or clarify technical features of methods proposed herein.

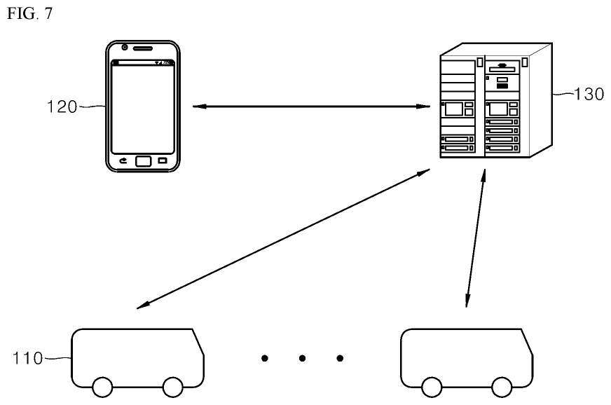

FIG. 7 is a schematic diagram of a system according to one embodiment of the present invention.

Referring to FIG. 7, a system 100 includes two or more autonomous vehicles 110, a terminal device 120, and a control server 130.

Each of the two or more autonomous vehicles 110 is a vehicle that drives without user intervention or with minimal user intervention. Hereinafter, “autonomous vehicle” will also be referred to as “vehicle” for convenience of description.

The terminal device 120 may be a smart phone possessed by a user and may provide a reservation service for use of the vehicle 110.

The control server 130 is communicatively connected to the two or more vehicles 110 and the terminal device 120. Through the control server 130, the two or more vehicles 110 may perform autonomous driving and a user may reserve the vehicle 110.

The control server 130 communicates with the two or more autonomous vehicles 110 and the terminal device 120. For example, each of the two or more autonomous vehicles 110 may communicate with the control server 130 via a 5G network. In addition, the terminal device 120 may also be in communication with the control server 130 via the 5G network.

A user is a member of a user group. The user group includes multiple users who know each other. For example, the user group may be a group of travelers who are mutual friends.

If the number of users belonging to the user group exceeds the seating capacity of one autonomous vehicle, the users need to split into a plurality of autonomous vehicles 110. In this case, the plurality of autonomous vehicles 110 may travel in a platoon under control of the control server 130.

For example, assuming the user group includes seven users and there are two 4-seater autonomous vehicles, four users may board one autonomous vehicle and three users may board the other autonomous vehicle.

In addition, the plurality of autonomous vehicles 110 interacts with the control server 130 to provide a service relating to platooning to the multiple users.

In one embodiment, the platooning-related service may be a service that allows the multiple users to feel as if the plurality of autonomous vehicles 110 is one autonomous vehicle 110.

More specifically, the multiple users, who know each other, want to have the same experience in one autonomous vehicle during travel. However, when the number of users exceeds the seating capacity of one autonomous vehicle, the users need to be split into plural autonomous vehicles 110. Thus, there is the disadvantage of not having the same experience.

Accordingly, the platooning-related service provided by the system 100 according to the present invention is a service that allows multiple users split into plural autonomous vehicles 100 to feel as if they are all together in one autonomous vehicle 110.

Next, provision of a service relating to platooning will be described in more detail with reference to the following drawings.

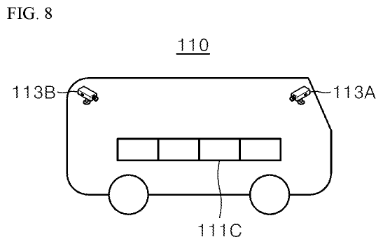

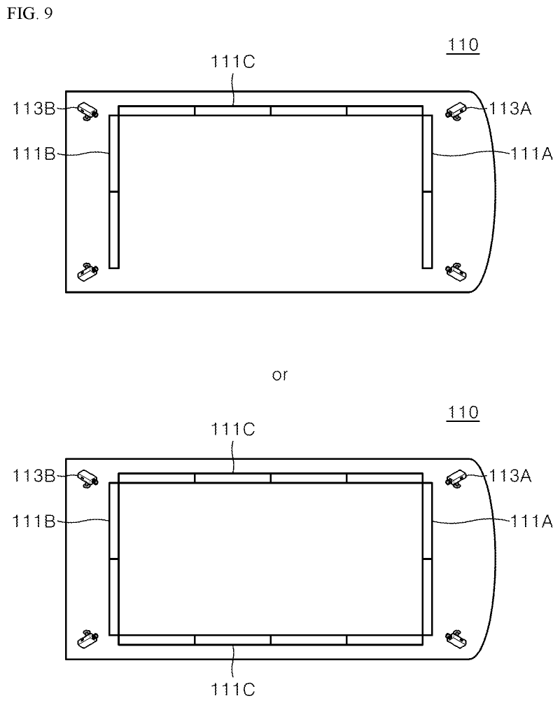

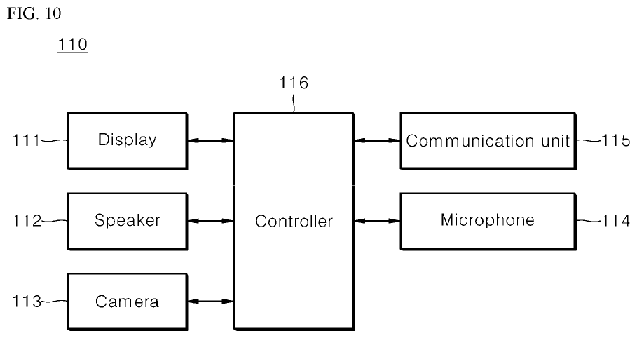

FIG. 8 is a sectional view of an autonomous vehicle 110 according to one embodiment of the present invention, FIG. 9 is a plan view of the autonomous vehicle 110, and FIG. 10 is a block diagram illustrating control relations between components of the autonomous vehicle 110.

Referring to FIG. 8 to FIG. 10, the autonomous vehicle 110 includes a plurality of displays 111, a plurality of speakers 112, a plurality of cameras 113, a plurality of microphones 114, a communication unit 115, and a controller 116.

The plurality of displays 111 is disposed inside the autonomous vehicle 110 and displays a specific image for a user. Here, the specific image may be an internal image of another autonomous vehicle, taken by the other autonomous vehicle, as described further below. Also, the image is a concept including a video.

The plurality of displays 111 may include a liquid crystal display (LCD), a light emitting diode (LED) display, an organic light emitting diode (OLED) display, and the like.

In one embodiment, the plurality of displays 111 may include at least one selected from the group consisting of a front display 111A, a rear display 111B, and a side display 111C.

The front display 111A may include at least one front display and is disposed at a front side in the autonomous vehicle 110. For example, the front display 111A may be disposed on an inner front side surface of the autonomous vehicle 110.

The rear display 111B may include at least one rear display and is disposed at a rear side in the autonomous vehicle 110. For example, the rear display 111B may be disposed on an inner rear side surface of the autonomous vehicle 110.

The side display 111C may include at least one side display and is disposed at one or both sides inside the autonomous vehicle 110. For example, the side display 111C may be disposed on one or both inner side surfaces of the autonomous vehicle 110.

The plurality of speakers 112 is disposed inside the autonomous vehicle 110 and outputs an audio signal corresponding to the specific image.

In one embodiment, the plural speakers 112 include at least one selected from the group consisting of a front speaker, a rear speaker, and a side speaker.

The front speaker may include at least one front speaker and may be disposed at a front side in the autonomous vehicle 110 to be adjacent to the front display 111A. The front speaker outputs an audio signal corresponding to an image displayed on the front display 111A.

The rear speaker may include at least one rear speaker and may be disposed at a rear side in the autonomous vehicle 110 to be adjacent to the rear display 111B. The rear speaker outputs an audio signal corresponding to an image displayed on the rear display 111B.

The side speaker may include at least one side speaker and may be disposed at one side in the autonomous vehicle 110 to be adjacent to the side display 111C. The side speaker outputs an audio signal corresponding to an image displayed on the side display 111C.

The plurality of cameras 113 is disposed inside the autonomous vehicle 110 and acquires an internal image of the autonomous vehicle 110.

In one embodiment, the plural cameras 113 may include at least one of a front camera 113A and a rear camera 113B, and optionally a side camera.

The front camera 113A may include at least one front camera and is disposed at a front side in the autonomous vehicle 110. For example, the front camera 113A may be disposed on an inner upper front surface of the autonomous vehicle 110.

The front camera 113A acquires a front image. Here, the front image is an internal image of the autonomous vehicle 110 and is acquired from an inner front side of the autonomous vehicle 110 to an inner rear side thereof.

The rear camera 113B may include at least one rear camera and is disposed at a rear side in the autonomous vehicle 110. For example, the rear camera 113B may be disposed on an inner upper rear surface of the autonomous vehicle 110.

The rear camera 113B acquires a rear image. Here, the rear image is an internal image of the autonomous vehicle 110 and is acquired from an inner rear side of the autonomous vehicle 110 to an inner front side thereof.

Although not shown in FIG. 8 and FIG. 9, the side camera may include at least one side camera and is disposed on one or both inner sides of the autonomous vehicle 110. For example, the side camera may be disposed on an inner right or left upper surface of the autonomous vehicle 110.

The side camera acquires a side image. Here, the side image is an internal image of the autonomous vehicle 110 and is acquired from one inner side of the autonomous vehicle 110 to the other inner side thereof.

The plurality of microphones 114 is disposed inside the autonomous vehicle 110 and receives an audio signal corresponding to the image acquired by the camera 113. In one embodiment, the camera 113 may be integrally configured with the microphone 114.

In one embodiment, the plural microphones 112 include at least one selected from the group consisting of a front microphone, a rear microphone and a side microphone.

The front microphone may include at least one front microphone and may be disposed at a front side in the autonomous vehicle 110 to be adjacent to the front camera 113A. The front microphone receives an audio signal corresponding to the image acquired by the front camera 113A.

The rear microphone may include at least one rear microphone and may be disposed at a rear in the autonomous vehicle 110 to be adjacent to the rear camera 113B. The rear microphone receives an audio signal corresponding to the image acquired by the rear camera 113B.

The side microphone may include at least one side microphone and may be disposed at one side in the autonomous vehicle 110 to be adjacent to the side camera. The side microphone receives an audio signal corresponding to the image acquired by the side camera.

The communication unit 115 is communicatively connected to the control server 130. The communication unit 115 may communicate with the control server 130 via a 5G network.

For example, the communicator 115 may receive, in real time, an internal image of another autonomous vehicle, acquired by the other autonomous vehicle, and an internal audio signal corresponding thereto. In addition, the communication unit 115 may transmit, in real time, internal images of the autonomous vehicle 100 acquired by the plurality of cameras 113 and internal audio signals received by the plurality of microphones 114 to the control server 130.

The controller 116 may be a processor-based device or module, may perform computing or data processing relating to control over and/or communication of at least one of the other components of the autonomous vehicle 110, and may control autonomous driving-related operation of the autonomous vehicle 110 by interacting with the control server 130.

For example, the controller 116 may control a corresponding one of the displays 111 to display an internal image of another autonomous vehicle, received from the control server 130, and control a corresponding one of the speakers 112 to output an internal audio signal of the other autonomous vehicle, received from the control server 130.

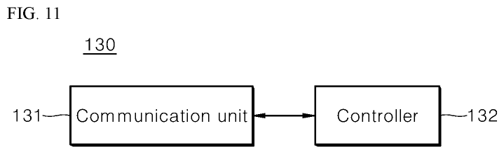

FIG. 11 is a schematic diagram of a control server 130 according to one embodiment of the present invention.

Referring to FIG. 11, the control server 130 includes a communication unit 131 and a controller 132.

The communication unit 131 communicates with two or more autonomous vehicles 110 and a terminal device 120. The communication unit 131 may communicate with the two or more autonomous vehicles 110 and the terminal device 120 via a 5G network.

For example, the communication unit 131 may receive an internal image of each of the two or more autonomous vehicles 110 and an internal audio signal corresponding thereto. In addition, the communication unit 131 may receive a request for vehicle services from the terminal device 120.

The controller 132 may control the communication unit 131, may select plural autonomous vehicles 110 from the two or more autonomous vehicles 110 based on the request for vehicle services, and may transmit information relating to platooning-related services to each of the selected autonomous vehicles 110. Here, the information relating to platooning-related services, which is transmitted to a first autonomous vehicle 110 among the selected autonomous vehicles 110, includes internal images and internal audio signals of the other selected autonomous vehicles 110.

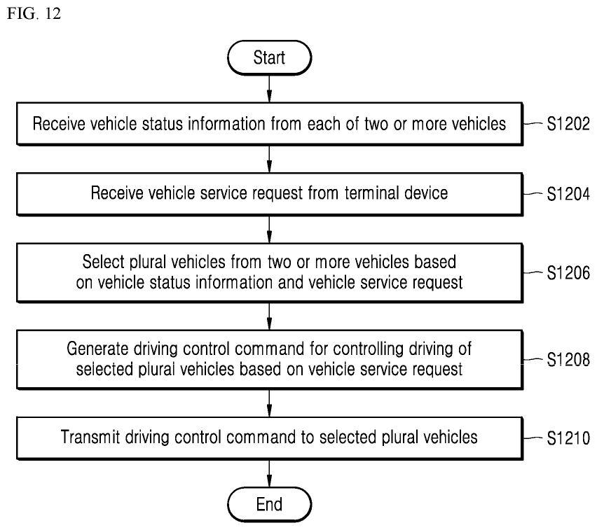

FIG. 12 is a flowchart illustrating operation of the control server 130 to select a plurality of autonomous vehicles 110 to provide driving services to a user group according to one embodiment of the present invention. Hereinafter, for convenience of description, “autonomous vehicle” will also be referred to as “vehicle”.

In step S1202, the communication unit 131 receives vehicle status information from each of two or more vehicles 110.

Here, the vehicle status information may include location of each vehicle 110 and whether each vehicle 110 is in operation.

In step S1204, the communication unit 131 receives a vehicle service request from the terminal device 120.

Here, the terminal device 120 may be a terminal device possessed by anyone in the user group. An application for receiving the vehicle service request may be installed in the terminal device 120, thereby allowing the terminal device 120 to transmit the vehicle service request using the application.

In addition, the vehicle service request includes the number of users (that is, the number of members of the user group), an origin of a route of travel, and a destination of the route.

In step S1206, the controller 132 selects plural vehicles 110 from the two or more vehicles 110 based on the vehicle status information and the vehicle service request.

For example, when there are seven users, the controller 132 may select two four-seater vehicles not in operation from among the two or more vehicles 110.

In step S1208, the controller 132 generates a driving control command for controlling driving of the selected plural vehicles 110 based on the vehicle service request.

In step S1210, the communication unit 131 transmits the driving control command to the selected plural vehicles 110.

The selected plural vehicles 110 move to the origin of the route where the user group is waiting based on the driving control command. After boarding, the selected plural vehicles 110 travel in a platoon to the destination of the route.

In one embodiment, the driving control command may be a command for controlling the plural vehicles 110 to arrive at the origin of the route at the same time.

More specifically, plural users belonging to the user group transmit the vehicle service request to travel from the origin of the route to the destination of the route.

If there is vehicle A whose seating capacity is enough for the plural users, all the plural users may board the vehicle A at the origin of the route and then may travel to the destination while having the same experience.

On the contrary, if vehicle A does not exist, plural vehicles, each having seating capacity not sufficient for the plural users, are deployed. In this case, if the plural vehicles arrive at the origin of the route at different times, the plural users will not have the same experience.

According to the present invention, the control server 130 can control autonomous driving of the plural vehicles 110 to allow the plural users to board the plural vehicles 110 at the same time.

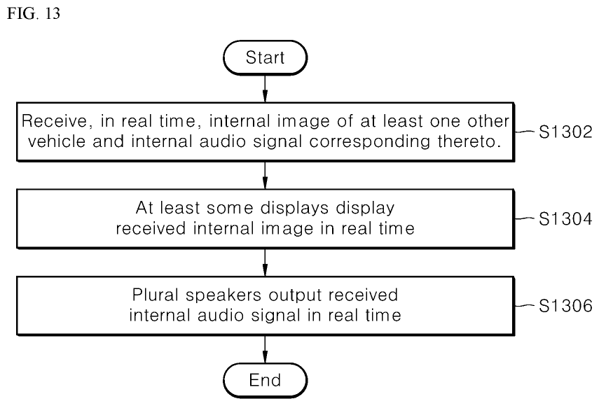

FIG. 13 is a flowchart illustrating a method of providing platooning-related services to a first vehicle 110 among vehicles 110 traveling in a platoon according to one embodiment of the present invention.

It will be understood that the method of FIG. 13 may also be applied to the other vehicles 110. Hereinafter, each step of the method will be described in detail.

In step S1302, the communication unit 115 receives, in real time, an internal image of at least one other vehicle traveling in a platoon with the first vehicle 110 and an internal audio signal corresponding thereto.

In step S1304, at least some of the plurality of displays 111 of the first vehicle display the received internal image in real time. This process may be performed under control of the controller 116.

In step S1306, the plurality of speakers 112 of the first vehicle outputs the received internal audio signal in real time. This process may be performed under control of the controller 116.

In one embodiment, the front display 111A of the first vehicle 110 may display a rear image of a first other vehicle among the at least one other vehicle, that is, an internal image of the first other vehicle acquired from an inner rear side of the first other vehicle to an inner front side thereof, and the front speaker of the first vehicle 110 may output a rear audio signal of the first other vehicle corresponding to the rear image of the first other vehicle. In this case, the first other vehicle may be a vehicle in front of the first vehicle 110.

In another embodiment, the rear display 111B of the first vehicle 110 may display a front image of a second other vehicle among the at least one other vehicle, that is, an internal image of the second other vehicle acquired from an inner front side of the second other vehicle to an inner rear side thereof, and the rear speaker of the first vehicle 110 may output a front audio signal of the second other vehicle corresponding to the front image of the second other vehicle.

In a further embodiment, the side display 111C of the first vehicle may display a side image of a third other vehicle among the at least one other vehicle, that is an internal image of the third other vehicle acquired from one inner side of the third other vehicle to the other inner side thereof, and the side speaker of the first vehicle may output a side audio signal of the third other vehicle corresponding to the side image of the third other vehicle.

The size of the internal image of the at least one other vehicle, displayed on each of the at least one display of the first vehicle, and the volume of the internal audio signal of the at least one other vehicle, output from each of the plural speakers, may be determined based on driving information on the at least one other vehicle. Here, the driving information on each of the at least one other vehicle may include at least one selected from among a speed of another vehicle, a distance between the first vehicle and the other vehicle, and an angle difference between the first vehicle and the other vehicle.

For example, the size of the internal image and the volume of the internal audio signal may be inversely proportional to the speed of another vehicle and the distance between the first vehicle and the other vehicle.

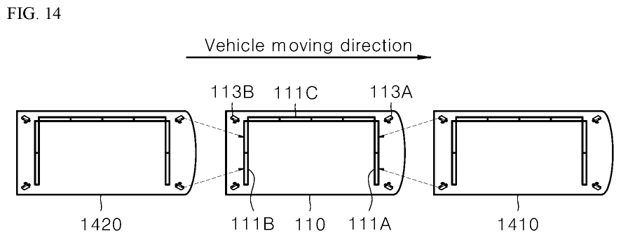

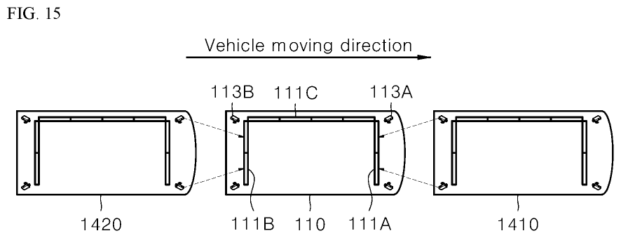

Next, the foregoing will be described in more detail with reference to FIG. 14 and FIG. 15.

FIG. 14 is a diagram illustrating an embodiment of a process of providing platooning-related services to three vehicles traveling in a platoon.

In this embodiment, it is assumed that a first vehicle 110 is in the middle, a first other vehicle 1410 is at the head, and a second other vehicle 1420 is at the tail. However, it will be understood that the present invention is not limited thereto.

A rear camera 1411 of the first other vehicle 1410 acquires a rear image of the first other vehicle, that is, an internal image of the first other vehicle acquired from the rear of the first other vehicle to the front thereof, and transmits the rear image to the first vehicle 110 via the control server 130. Then, a front display 111A of the first vehicle 110 displays the rear image of the first other vehicle.

In particular, an image acquired by a left rear camera 1411 of the first other vehicle 1410 is displayed on a left front display 111A of the first vehicle 110, and an image acquired by a right rear camera 1411 of the first other vehicle 1410 is displayed on a right front display 111A of the first vehicle 110.

On the other hand, there may be an overlap between the image acquired by the left rear camera of the first other vehicle 1410 and the image acquired by the right rear camera of the first other vehicle 1410. In this case, the controller of the first vehicle 110 may make a correction by removing the overlap from any one of the two rear images. As a result, the front display 111A of the first vehicle 110 can display rear images of the first other vehicle 1410 without any overlap.

In addition, a rear microphone of the first other vehicle 1410 may receive a rear audio signal of the first other vehicle 1410 and transmit the rear audio signal to the first vehicle 110 via the control server 130. Then, a front speaker of the first vehicle 110 may output the rear audio signal of the first other vehicle 1410.

As described above, the size of the internal image of the first other vehicle 1410, displayed on the front display 111A of the first vehicle 110, and the volume of the rear audio signal of the first other vehicle 1410, output from the front speaker of the first vehicle 110, may be determined based on a speed of the first other vehicle 1410 or a distance between the first vehicle 110 and the first other vehicle 1410.

For example, when the speed of the first other vehicle 1410 is less than a predetermined reference value or when the distance between the first vehicle 110 and the first other vehicle 1410 is less than a predetermined reference value, the front display 111A of the first vehicle 110 may display the internal image of the first other vehicle 1410 in a larger size and the front speaker of the first vehicle 110 may output the rear audio signal of the first other vehicle 1410 at a higher volume.

For another example, when the speed of the first other vehicle 1410 exceeds a predetermined reference value, or when the distance between the first vehicle 110 and the first other vehicle 1410 exceeds a predetermined reference value, the front display 111A of the first vehicle 110 may display the internal image of the first other vehicle 1410 in a smaller size and the front speaker of the first vehicle 110 may output the rear audio signal of the first other vehicle 1410 at a lower volume.

In addition, a front camera 1421 of the second other vehicle 1420 acquires a front image of the second other vehicle 1420, that is, an internal image of the second other vehicle acquired from the front of the second other vehicle to the rear thereof, and transmits the front image to the first vehicle 110 via the control server 130. Then, a rear display 111B of the first vehicle 110 outputs the front image of the second other vehicle 1420.

In particular, an image acquired by a left front camera 1421 is displayed on a left rear display 111B, and an image acquired by a right front camera 1421 is displayed on a right rear display 111B.

As described above, there may be an overlap between the image acquired by the left front camera of the second other vehicle 1420 and the image acquired by the right front camera of the second other vehicle 1420. In this case, the controller of the first vehicle 110 may make a correction by removing the overlap from any one of the two front images. As a result, the front display 111B of the first vehicle 110 can display front images of the first other vehicle 1410 without any overlap.

In addition, a front microphone of the second other vehicle 1420 may receive a front audio signal of the second other vehicle 1420 and transmit the front audio signal to the first vehicle 110 via the control server 130. Then, a rear speaker of the first vehicle 110 may output the front audio signal of the second other vehicle 1420.

Similar to the foregoing example, the size of the internal image of the second other vehicle 1420, displayed on the rear display 111B of the first vehicle 110, and the volume of the front audio signal of the second other vehicle 1420, output from the rear speaker of the first vehicle 110, may be determined based on a speed of the second other vehicle 1420 or a distance between the first vehicle 110 and the second other vehicle 1420.

The control server 130 transmits image content to the first vehicle 110 and the other vehicles 1410, 1420. Then, a side display of each of the first vehicle 110 and the other vehicles 1410, 1420 may display the image content. Here, the control server 130 may receive the image content from an image content server. For example, the image content may include entertainment image content, advertisement image content, and the like.

The controller 132 of the control server 130 may divide the image content into plural pieces of sub-image content corresponding in number to the plural vehicles. Then, the control server 130 may transmit the plural pieces of sub-image content to the respective plural vehicles. Each sub-image content may be synchronized to be displayed on the side display of a corresponding one of the plural vehicles.

In the embodiment of FIG. 14, the controller 132 may divide the image content into three pieces of sub-image content and transmit the three pieces of sub-image content to the first vehicle 110, the first other vehicle 1410, and the second other vehicle 1420, respectively.

The first vehicle 110 may display first sub-image content on the side display 111C thereof, the first other vehicle 1410 may display second sub-image content on the side display thereof, and the second other vehicle 1420 may display third sub-image content on the side display thereof.

At least one user in the first vehicle 110 may view the second sub-image content and the third sub-image content through the front display 111A and the rear display 111B of the first vehicle 110, respectively. In addition, at least one user in each of the other vehicles 1410, 1420 may view the other sub-image content through the front/rear displays.

That is, at least one user in the first vehicle 110 can observe a situation of the first other vehicle 1410 in a see-through manner through the front display 111A and the front speaker and can observe a situation of the second other vehicle 1420 in a see-through manner through the rear display 111B and the rear speaker.

Similarly, each of the other vehicles 1410, 1420 may also receive the front image, rear image, front audio signal, and rear audio signal of the first vehicle 110 and may output these image and audio signals through the displays and speakers thereof. As a result, at least one user in each of the other vehicles 1410, 1420 can also observe a situation of the first vehicle 110 in a see-through manner.

Therefore, according to this embodiment, three different vehicles can be virtually combined into one vehicle, thereby allowing plural users split into the vehicles to enjoy the experience of traveling together in one virtually constructed vehicle environment.

FIG. 15 is a diagram illustrating a process of providing platooning-related services to two vehicles traveling in a platoon according to another embodiment of the present invention.

In this embodiment, it is assumed that a first vehicle 110 travels in parallel with the other vehicle 1510. However, it will be understood that the present invention is not limited thereto.

An image acquired by a left front camera of the other vehicle 1510 and an image acquired by a left rear camera of the other vehicle 1510 are transmitted to the first vehicle 110 via the control server 130. If there is a left side camera in the other vehicle 1510, an image acquired by the left side camera of the other vehicle 1510 is also transmitted to the first vehicle 110.

Then, a right side display 111C of the first vehicle 110 displays the images received from the other vehicle 1510. Here, the right side display may display the images with an overlap between the images removed, as described above.

In addition, an image acquired by a right front camera of the first vehicle 110 and an image acquired by a right rear camera of the first vehicle (110) are transmitted to the other vehicle 1510 via the control server 130. If there is a right side camera in the first vehicle 110, an image acquired by the right side camera of the first vehicle 110 is also transmitted to the other vehicle 1510.

Then, a left side display of the other vehicle 1510 displays the images received from the first vehicle 110. Here, the left side display may display the images with an overlap between the images removed, as described above.

That is, at least one user in the first vehicle 110 can observe a situation of the other vehicle 1510 in a see-through manner through the right side display 111C of the first vehicle, and at least one user in the other vehicle 15100 can observe a situation of the first vehicle 110 in a see-through manner through the left side display of the other vehicle.

Therefore, according to this embodiment, two different vehicles can be virtually combined into one vehicle, thereby allowing plural users split into the vehicles to enjoy the experience of traveling together in one virtually constructed vehicle environment.

Although all the elements constituting the embodiments of the present invention have been described as being combined into one or combined with one another to operate, it should be understood that the present invention is not limited thereto and at least one of the elements may be selectively combined with one another to operate. Further, all the elements may be implemented as respective independent hardware devices, but some or all of the elements may also be selectively combined and implemented in the form of a computer program having program modules which perform some or all of the functions combined by one or more hardware devices. Code and code segments constituting the computer program may be easily conceived by those skilled in the art. Such a computer program is stored in computer readable storage media and is read and executed by the computer to implement the embodiments of the present invention. Examples of the storage media for storing the computer program may include magnetic recording media, optical recording media, semiconductor recording media, and the like. In addition, the computer program for implementing the embodiments of the present invention includes a program module that is transmitted in real time via an external device.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention. The scope of the present invention should be defined by the appended claims and equivalents thereto.

What is claimed is:

1. A vehicle performing autonomous driving, comprising:
a plurality of displays disposed the vehicle;
a plurality of speakers disposed the vehicle;
a communication unit configured to receive, in real time, an internal image of at least one other vehicle autonomously driving in a platoon with the vehicle and an internal audio signal corresponding to the internal image; and
a controller configured to control at least some of the plurality of displays to display the internal image in real time and controlling the plurality of speakers to output the internal audio signal in real time.

2. The vehicle according to claim 1, wherein:
the plurality of displays comprises a front display disposed at a front side within the vehicle, the front display displaying a rear image of a first other vehicle among the at least one other vehicle, the rear image being acquired from an inner rear side of the first other vehicle to an inner front side of the first other vehicle; and
the plurality of speakers comprises a front speaker disposed adjacent to the front display, the front speaker outputting a rear internal audio signal of the first other vehicle corresponding to the rear image of the first other vehicle.

3. The vehicle according to claim 1, wherein:
the plurality of displays comprises a rear display disposed at a rear side within the vehicle, the rear display displaying a front image of a second other vehicle among the at least one other vehicle, the front image being acquired from an inner front side of the second other vehicle to an inner rear side of the second other vehicle; and
the plurality of speakers comprises a rear speaker disposed adjacent to the rear display, the rear speaker outputting a front internal audio signal of the second other vehicle corresponding to the front image of the second other vehicle.

4. The vehicle according to claim 1, wherein:
the plurality of displays comprises a side display disposed at a lateral side within the vehicle, the side display displaying a side image of a third other vehicle among the at least one other vehicle, the side image being acquired from one inner side of the third other vehicle to the other inner side of the third other vehicle; and
the plurality of speakers comprises a side speaker disposed adjacent to the side display, the side speaker outputting a side internal audio signal of the third other vehicle corresponding to the side image of the third other vehicle.

5. The vehicle according to claim 1, wherein a size of the internal image displayed on at least one of the displays and a volume of the internal audio signal output from the plurality of speakers are determined based on driving information on the at least one other vehicle, the driving information comprising at least one selected from among a speed of the at least one other vehicle, a distance between the vehicle and the at least one other vehicle, and an angle difference between the vehicle and the at least one other vehicle.

6. The vehicle according to claim 5, wherein the size of the internal image and the volume of the internal audio signal are inversely proportional to the speed and the distance.

7. The vehicle according to claim 1, wherein the at least one other vehicle generates the internal image and the internal audio signal and transmits, in real time, the generated internal image and internal audio signal to an external control server, and the communication unit receives the internal image and the internal audio signal from the control server.

8. The vehicle according to claim 7, further comprising:
a plurality of cameras disposed the vehicle; and
a plurality of microphones disposed the vehicle,
wherein the plurality of cameras acquires an internal image of the vehicle in real time, the plurality of microphones receives an internal audio signal of the vehicle in real time and the communication unit transmits the internal image of the vehicle and the internal audio signal of the vehicle to the control server in real time.

9. The vehicle according to claim 8, wherein the plurality of cameras comprises at least one of a front camera, a rear camera, and a side camera, the front camera being disposed at a front side within the vehicle to acquire a front image of the vehicle, the rear camera being disposed at a rear side within the vehicle to acquire a rear image of the vehicle, the side camera being disposed at a lateral side within the vehicle to acquire a side image of the vehicle.

10. The vehicle according to claim 9, wherein the front image of the vehicle is acquired from an inner front side of the vehicle to an inner rear side of the vehicle, the rear image of the vehicle is acquired from an inner rear side of the vehicle to an inner front side of the vehicle, and the side image of the vehicle is acquired from one inner side of the vehicle to the other inner side of the vehicle.

11. The vehicle according to claim 8, wherein the communication unit receives first sub-image content from the control server, the first sub-image content being one of plural pieces of sub-image content obtained by dividing image content, at least one of the plurality of displays the first sub-image content, and the other pieces of sub-image content are displayed on respective displays of the at least one other vehicle.

12. A control server comprising:
a communication unit configured to communicate with plural vehicles performing autonomous driving; and
a controller configured to control autonomous driving of the plural vehicles,
wherein, when the plural vehicles travel in a platoon, the communication unit receives, in real time, an internal image of each of the plural vehicles and an internal audio signal corresponding to the internal image, the controller generates information about platooning-related services for the plural vehicles based on the received internal image and internal audio signal, and the communication unit transmits, in real time, the information about platooning-related services to the plural vehicles, and
wherein the information about platooning-related services for a first vehicle among the plurality of vehicles comprises an internal image and internal audio signal of each of the other vehicles.

13. The control server according to claim 12, wherein the internal image of each of the other vehicles comprises at least one selected from among a front image, a rear image, and a side image, the front image being acquired from an inner front side of each of the other vehicles to an inner rear side of each of the other vehicles, the rear image being acquired from an inner rear side of each of the other vehicles to an inner front side of each of the other vehicles, and the side image being acquired from one inner side of each of the other vehicles to the other inner side of each of the other vehicles.

14. The control server according to claim 12, wherein the communication unit receives image content from a content server, the controller divides the image content into plural types of sub-content based on in number to the plural vehicles, the communication unit transmits the plural types of sub-content to the respective plural vehicles, and the plural types of sub-content is synchronized to be displayed on the respective plural vehicles.

15. The control server according to claim 12, wherein;
prior to platooning of the plural vehicles, the communication unit is communicatively connected to a terminal device and two or more vehicles including the plural vehicles and receives vehicle status information from the two or more vehicles and a vehicle service request from the terminal device, the vehicle service request comprising the number of users, an origin of a route of travel, and a destination of the route; and
the controller selects the plural vehicles among the two or more vehicles based on the vehicle status information and the vehicle service request and generates a driving control command for controlling driving of the plural vehicles based on the vehicle service request, the driving control command being a command for controlling the plural vehicles to arrive at the origin of the route at the same time.

16. A method of controlling a vehicle performing autonomous driving and comprising a communication unit, a plurality of displays, and a plurality of speakers, the method comprising:
receiving, by the communication unit, in real time, an internal image of at least one other vehicle autonomously driving in a platoon with the vehicle and an internal audio signal corresponding to the internal image;
displaying, by at least some of the plurality of displays, the internal image in real time; and
outputting, by the plurality of speakers, the internal audio signal in real time.

17. The method according to claim 16, wherein the plurality of displays comprises a front display disposed at a front side within the vehicle and the plurality of speakers comprises a front speaker disposed adjacent to the front display, and
wherein the step of displaying the internal image comprises displaying, by the front display, a rear image of a first another vehicle among the at least one other vehicle, the rear image being acquired from an inner rear side of the first other vehicle to an inner front side of the first other vehicle, and
the step of outputting the internal audio signal comprises outputting, by the front speaker, a rear internal audio signal of the first other vehicle corresponding to the rear image of the first other vehicle.

18. The method according to claim 16, wherein the plurality of displays comprises a rear display disposed at a rear side within the vehicle and the plurality of speakers comprises a rear speaker disposed adjacent to the rear display, and
wherein the step of displaying the internal image comprises displaying, by the rear display, a front image of a second other vehicle among the at least one other vehicle, the front image being acquired from an inner front side of the second other vehicle to an inner rear side of the second other vehicle, and
the step of outputting the internal audio signal comprises outputting, by the rear speaker, a front internal audio signal of the second other vehicle corresponding to the front image of the second other vehicle.

19. The method according to claim 16, wherein the plurality of displays comprises a side display disposed at a lateral side within the vehicle and the plurality of speakers comprises a side speaker disposed adjacent to the side display, and
wherein the step of displaying the internal image comprises displaying, by the side display, a side image of a third other vehicle among the at least one other vehicle, the side image being acquired from one inner side of the third other vehicle to the other inner side t of the third other vehicle, and
the step of outputting the internal audio signal comprises outputting, by the side speaker, a side internal audio signal of the third other vehicle corresponding to the side image of the third other vehicle.
